(19) United States
(12) Patent Application Publication
(10) Pub. No.: US 2011/0269373 A1
(43) Pub. Date: Nov. 3, 2011

(54) Collapsible structures with carrying feature

(76) Inventors: Yu Zheng, Walnut, CA (US); Rachel Lee Zheng, Walnut, CA (US); Alicia Lea Zheng, Walnut, CA (US)

(21) Appl. No.: 12/799,747

(22) Filed: Apr. 29, 2010

(51) Int. Cl. A63H 33/00; B23P 19/04

(52) U.S. Cl. 446/478; 29/700

(57) ABSTRACT

A collapsible structure has a plurality of panels, each panel having a foldable frame member that has a folded and an unfolded orientation, with a fabric material covering portions of each respective frame member to form the panel for each frame member when the frame member is in the unfolded orientation. The left side of each panel is hingedly coupled to the right side of an adjacent panel to form a ring of panels. A first cover piece defining a planar body is attached to the first panel, and a second cover piece defining a planar body is attached to the second panel. The panels are twisted and folded so that the frame members of the panels are in their folded orientation so as to reduce the size of the panels, with the panels sandwiched between the first and second cover pieces.

### BACKGROUND OF THE INVENTION

1. Field of the Invention

The present invention relates to collapsible structures, and in particular, to collapsible structures that can be more conveniently carried about by the user after the structure has been twisted and folded into its collapsed configuration.

2. Description of the Prior Art

There are presently many collapsible structures that are being provided for use by children and adults in a number of different applications. Examples of these collapsible structures are illustrated in the following patents: U.S. Pat. Nos. 5,816,954 (Zheng), 6,006,772 (Zheng), 5,778,915 (Zheng), 5,467,794 (Zheng), 5,975,101 (Zheng), 5,722,446 (Zheng), 4,858,634 (McLeese), 4,825,592 (Norman), 5,964,533 (Ziglar), 5,971,188 (Kellogg et al.), 6,485,344 (Arias), 6,343,391 (LeGette), U.S. Pub. No. 2004/0139997 (Zheng) and U.S. Pat. No. 5,038,812 (Norman), among others. These collapsible structures are supported by one or more frame members that can be twisted and folded to reduce the overall size of the structure. These collapsible structures can be used in a wide variety of applications, such as containers, tents, play structures, executive toys, shelters, sports structures, and others. As a result, collapsible structures have become very popular.

### SUMMARY OF THE DISCLOSURE

It is an object of the present invention to provide a collapsible structure that can be more conveniently carried about by the user after the structure has been twisted and folded into its collapsed configuration.

It is another object of the present invention to provide a collapsible structure that has additional features that enhance the play variety or uses that are available for the structure.

In order to accomplish the objects of the present invention, the present invention provides a collapsible structure that has a plurality of panels, each panel having a foldable frame member that has a folded and an unfolded orientation, with a fabric material covering portions of each respective frame member to form the panel for each frame member when the frame member is in the unfolded orientation. The left side of each panel is hingedly coupled to the right side of an adjacent panel to form a ring of panels. A first cover piece defining a planar body is attached to the first panel, and a second cover piece defining a planar body is attached to the second panel. The panels are twisted and folded so that the frame members of the panels are in their folded orientation so as to reduce the size of the panels, with the panels sandwiched between the first and second cover pieces.

### BRIEF DESCRIPTION OF THE DRAWINGS

FIG. 1 is a perspective view of a collapsible structure according to one embodiment of the present invention.

FIGS. 2A through 2F illustrate how the collapsible structure of FIG. 1 may be twisted and folded for compact storage.

FIG. 3 is a partial cut-away view of the section A of the structure of FIG. 1 illustrating a frame member retained within a sleeve.

FIG. 4 is a cross-sectional view of the section 4-4 in FIG. 1.

FIGS. 5-9 illustrate other embodiments of collapsible assemblies according to the present invention.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

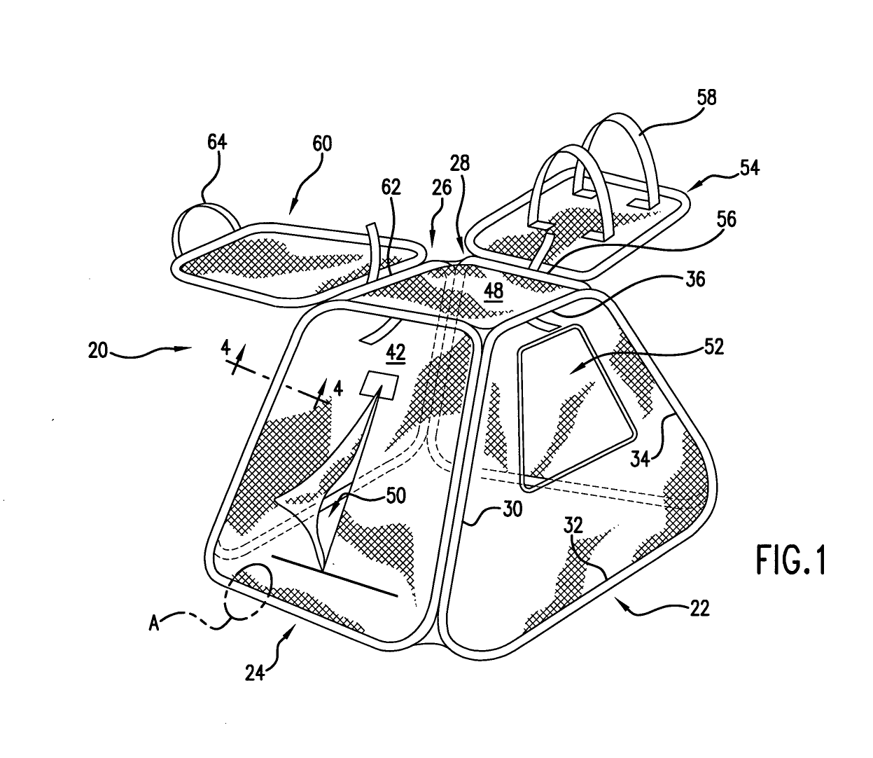

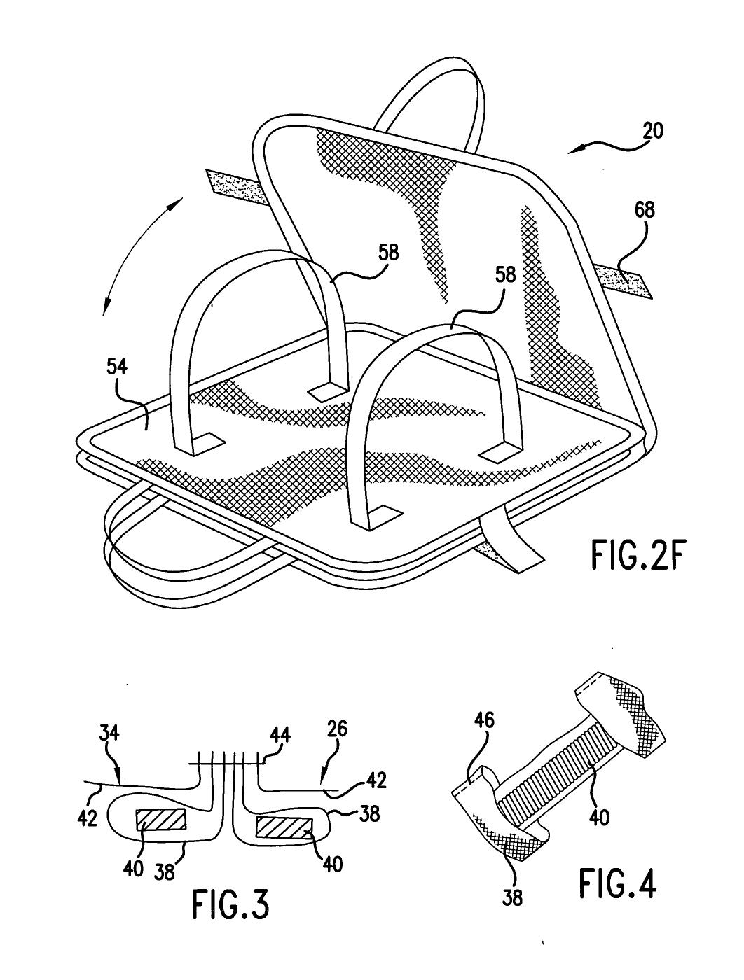

As shown in FIGS. 1 and 3, a collapsible structure 20 according to one embodiment of the present invention can have four panels 22, 24, 26 and 28 connected to each other to encircle an enclosed space. Each panel 22, 24, 26, 28 can have four sides, such as a left side 30, a bottom side 32, a right side 34 and a top side 36, although each panel 22, 24, 26, 28 can assume any configuration and have any number of sides. Each panel 22, 24, 26, 28 has a frame retaining sleeve 38 provided along and traversing the four edges of its four sides 30, 32, 34, 36. A frame member 40 is retained or held within each respective frame retaining sleeve 38 to support each respective panel 22, 24, 26, 28. Only the frame member 40 is shown in FIG. 3; the other frame members are not shown but are the same as frame member 40.

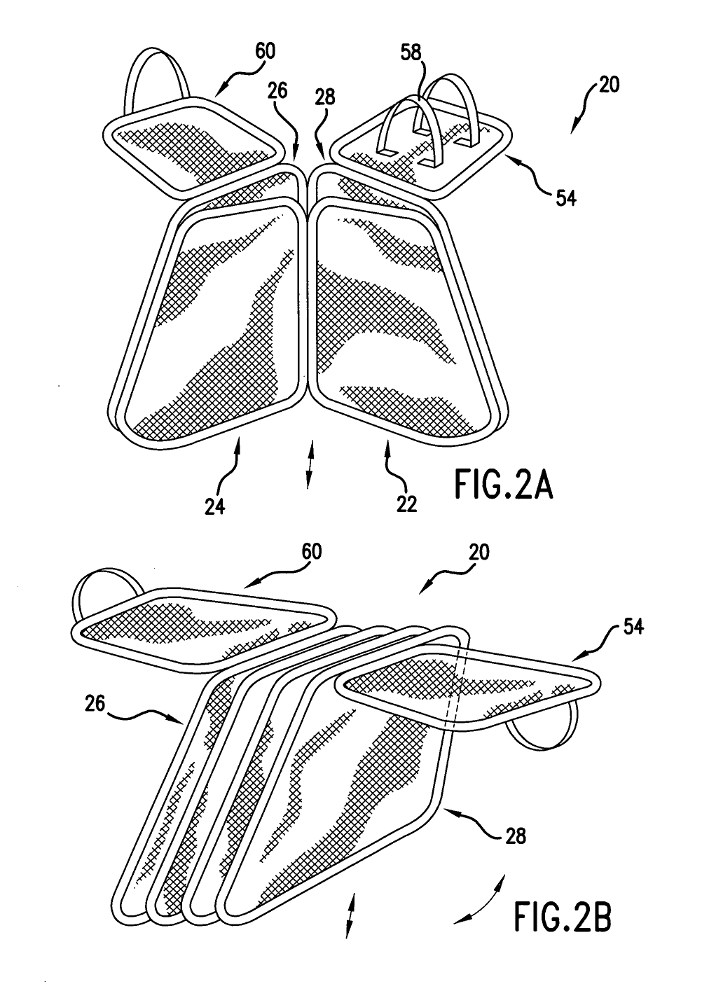

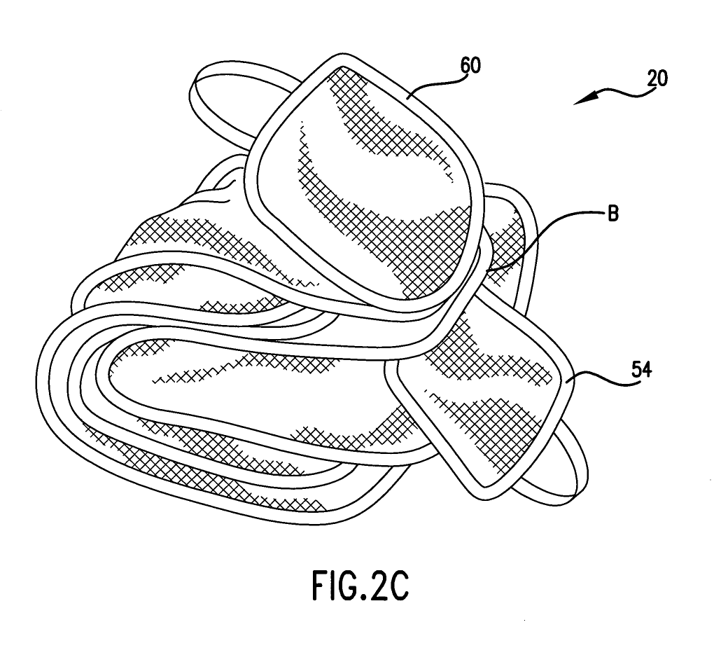

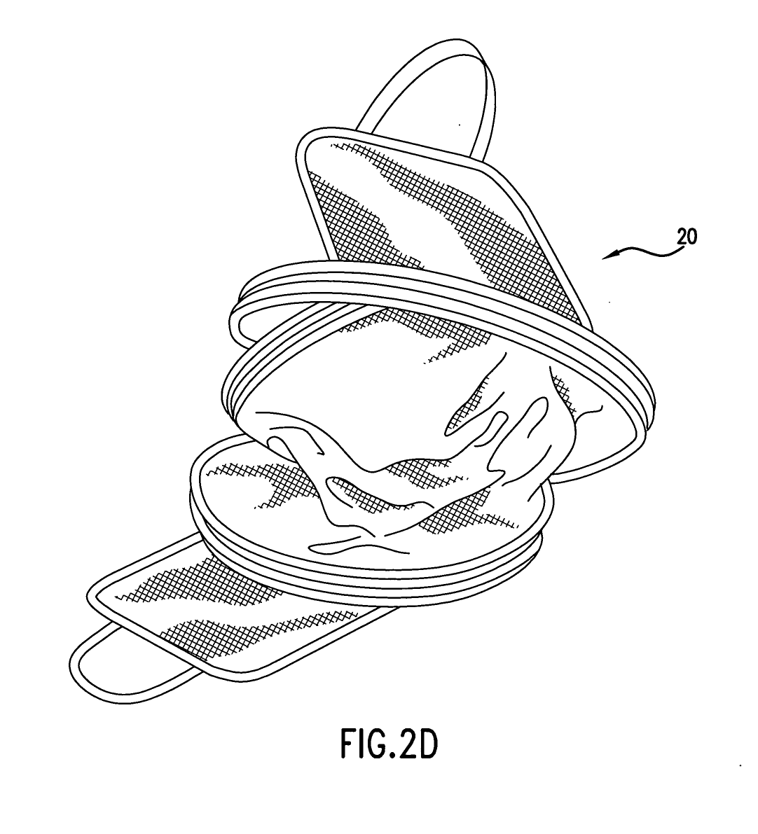

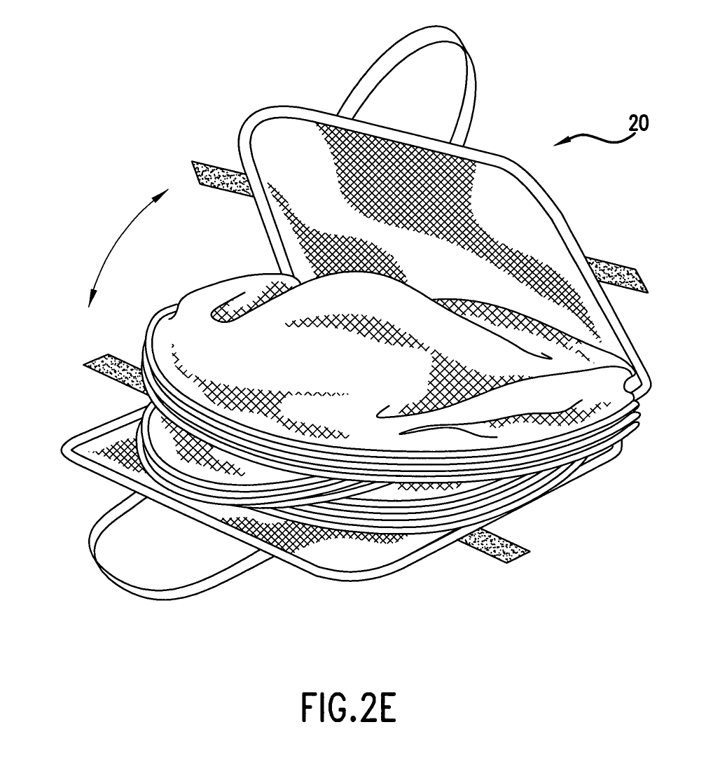

The frame members 40 may be provided as one continuous loop, or may comprise a strip of material connected at both ends to form a continuous loop. The frame members 40 are preferably formed of flexible coilable steel, although other materials such as plastics may also be used. The frame members 40 should be made of a material which is relatively strong and yet is flexible to a sufficient degree to allow it to be coiled. Thus, each frame member 40 is capable of assuming two positions or orientations, an open or expanded position such as shown in FIG. 1, or a folded position in which the frame member 40 is collapsed into a size which is much smaller than its open position (see FIG. 2F).

Fabric or sheet material 42 extends across each respective panel 22, 24, 26, 28, and is held taut by the respective frame member 40 when in its open position. The term fabric is to be given its broadest meaning and should be made from lightweight but strong materials and may include cottons, woven fabrics, sheet fabrics, films and any material suitable for wearing as a costume. The fabric can be water-resistant, and should be durable to withstand the wear and tear associated with rough treatment. The frame members 40 may be merely retained within the respective frame retaining sleeves 38 without being connected thereto. Alternatively, the frame retaining sleeves 38 may be mechanically fastened, stitched, fused, or glued to the respective frame members 40 respectively, to retain them in position.

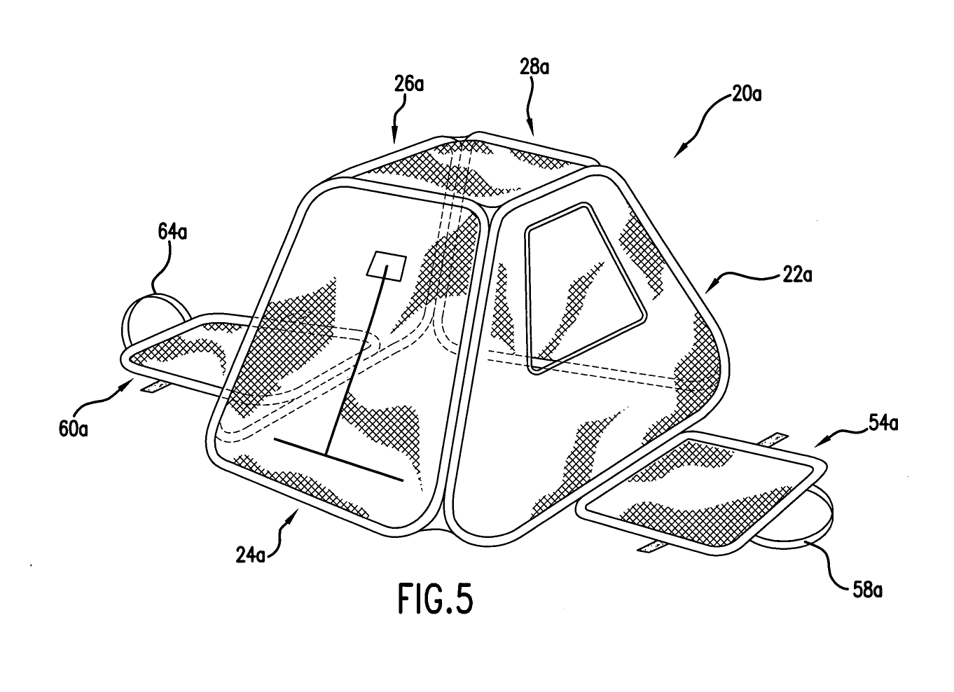

FIG. 4 illustrates one possible connection for connecting adjacent edges of two panels 24 and 26. The fabric pieces 42 are stitched at their edges by a stitching 44 to the respective sleeves 38. Each sleeve 38 may be formed by folding a piece of fabric. The stitching 44 also acts as a hinge for the panels 24 and 26 to be folded upon each other, as explained below. The connections for the three other pairs of adjacent edges may be identical. Thus, the connections on the left side 30 and the right side 34 of each panel 22, 24, 26, 28 act as hinge connections for connecting an adjacent panel.

At the top side 36 and the bottom side 32 of each panel 22, 24, 26, 28 where there is no hinge connection to an adjacent panel, the frame retaining sleeve 38 may be formed by merely folding over the corresponding fabric piece and applying a stitching 46 (see FIG. 3). The fabric piece 42 for the corresponding panel may then be stitched to the sleeve 38. A top piece of fabric 48 can be stitched or otherwise attached to the top sides 36 of the panels 22, 24, 26, 28.

Openings 50 and 52 may be provided in some or all of the panels 22, 24, 26, 28. These openings 50 and 52 may be of any shape (e.g., triangular, circular, rectangular, square, diamond, etc.) and size, and can be even embodied in the form of a plurality of slits (i.e., see 50). The openings can be provided to facilitate different functions; for example, the opening 50 can be used to provide access to the interior of the structure 20 (which can be a tent or shelter), and the opening 52 can function as a window.

The fabric 42 on each of the panels 22, 24, 26, 28 can be provided with any desired decoration, design, pattern or indicia to provide any desired theme or illustration, depending on what the structure 20 is being used for. For example, a camouflage pattern can be provided on the fabric 42 if the structure 20 is a hunting blind.

A first cover piece 54 can be hingedly connected to a side (e.g., the top side 36) of a panel (e.g., panel 28). The cover piece 54 can be configured to be the same as any of the panels 22, 24, 26, 28, having a frame member 40 which supports a fabric material 42 to define a planar body. In such an embodiment, the cover piece 54 has a side 56 that can hingedly connected to the side 36 of the panel 28 using the same connection shown in FIG. 4. The cover piece 54 can be used for two purposes. First, it can cover an opening (similar to 52, but on the panel 28). Second, it can be used to bind and store the structure 20, as shown and described below in connection with FIGS. 2A-2F. In addition, straps 58 can be provided on the fabric 42 of the cover piece 54 in a manner similar to straps for a backpack for allowing a user to carry the cover piece 54 (and the structure 20) on the user's back. The cover pieces 54 can be sized and configured to be smaller than the panels 22, 24, 26, 28, and therefore do not need to be twisted and folded into a smaller configuration. In this regard, the structure 20 can even be a hamper or similar container which can be reduced in size (when not in use) and then carried by the user like a backpack.

A second cover piece 60 can be hingedly connected to a side (e.g., the top side 36) of another panel (e.g., panel 26). The cover piece 60 can be configured to be the same as any of the panels 22, 24, 26, 28, having a frame member 40 which supports a fabric material 42 to define a planar body. In such an embodiment, the cover piece 60 has a side 62 that can hingedly connected to the side 36 of the panel 26 using the same connection shown in FIG. 4. The cover piece 60 can also be used in connection with the other cover piece 54 to bind and store the structure 20, as shown and described below in connection with FIGS. 2A-2F. In addition, a handle 64 can be provided along another side 66 of the cover piece 60.

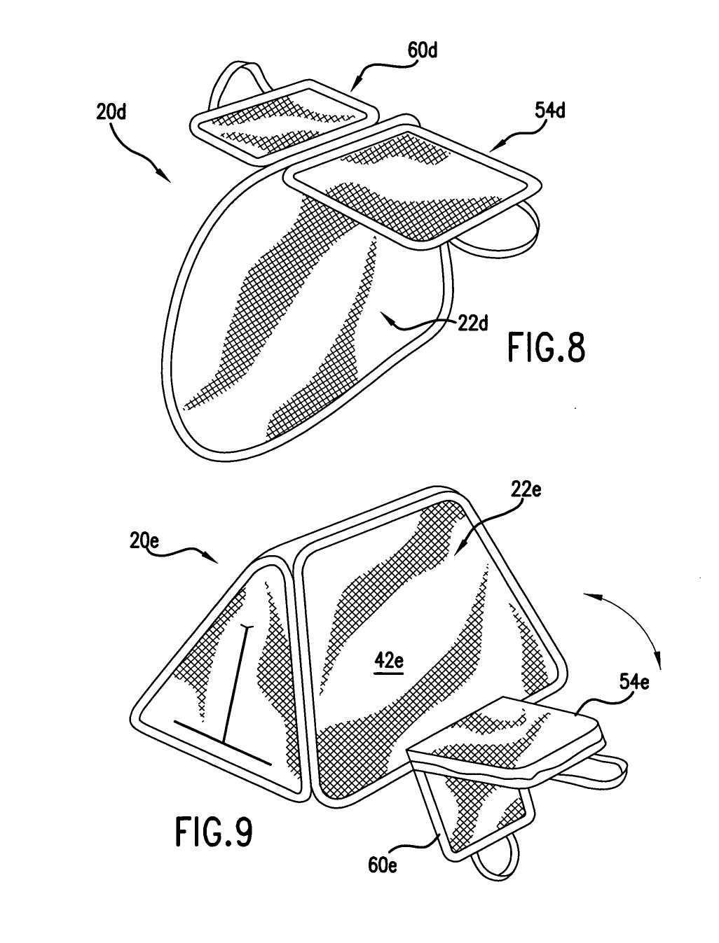

While the structure 20 is shown and described as having four panels, each having four sides, it will be appreciated that the structure 20 may be made of any number of panels, each having any number of sides, without departing from the spirit and scope of the present invention. For example, each structure may have at least one panel (see FIG. 8 below) or two or more panels, and each panel may have three or more sides. Thus, the structures of the present invention may take a variety of external shapes. However, each panel, regardless of its shape, is supported by at least one frame member 40.

FIGS. 2A through 2F describe the various steps for folding and collapsing the structure 20 for storage. The first step consists of pushing panels 22 and 24 towards panels 28 and 26, respectively, about their hinged connections so that panel 22 collapses upon panel 28 and panel 24 collapses upon panel 26. See FIG. 2A. Then, in the second step shown in FIG. 2B, the two panels 22 and 28 are folded so as to be collapsed upon the two panels 24 and 26 to form a stack of four panels. In the third step (see FIG. 2C), the structure 20 is then twisted and folded to collapse the frame members 40 and panels 22, 24, 26, 28 into a smaller shape. In particular, the opposite border B of the stack of panels 22, 24, 26, 28 is folded in upon the previous fold to further collapse the frame members 40 with the panels. As shown in FIG. 2D, the folding is continued so that the initial size of the structure 20 is reduced until the frame members 40 and panels are collapsed on each other (see FIG. 2E) to provide for a small essentially compact configuration having a plurality of concentric frame members 40 and layers of the panels 22, 24, 26, 28 so that the collapsed structure 20 has a size which is a fraction of the size of the initial structure. The cover pieces 54 and 60 are then collapsed against each other so that the collapsed panels 22, 24, 26, 28 are sandwiched between the cover pieces 54, 60 (see FIG. 2F), and then connectors 68 provided on the cover pieces 54, 60 can be connected to secure the cover pieces 54, 60 together. These connectors 68 can be embodied in the form of opposing VELCRO™ pads, straps, ties, hooks or even zippers. The structure 20 is now neatly folded and collapsed into the form of a bag-like assembly with the cover pieces 54, 60 acting as the outer panels of the bag-like assembly, and the user can then use the straps 58 to carry the structure 20 on his or her back like a backpack.

FIG. 5 illustrates another embodiment according to the present invention, where the structure 20a is the same as the structure 20 shown in FIG. 1 except that the cover pieces 54a and 60a are hingedly connected to the bottom sides 32a of the panels 22a and 26a, respectively. Otherwise the same elements in both FIGS. 1 and 5 are represented by the same numeral designations except that an “a” is added to the designations in FIG. 5.

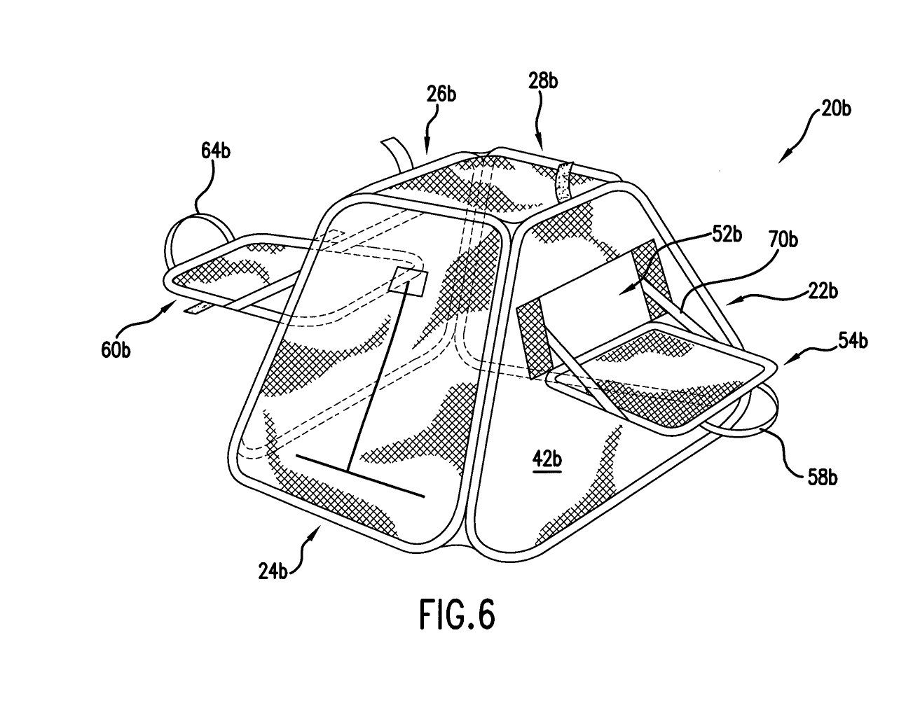

FIG. 6 illustrates another embodiment according to the present invention, where the structure 20b is the same as the structure 20 shown in FIG. 1 except that the cover pieces 54b and 60b are hingedly connected to the fabric material 42b of the panels 22b and 26b, respectively. Otherwise the same elements in both FIGS. 1 and 6 are represented by the same numeral designations except that a “b” is added to the designations in FIG. 6. Each cover piece 54b, 60b can be hingedly connected (e.g., by stitching) to the bottom edge of a corresponding opening 52b (acting as a window), and supported by straps 70b that have opposite ends connected to the fabric material 42b and the cover piece 54b, 60b, so that each cover piece 54b, 60b can be used as a pivoting window cover, as well as functioning to bind and store the structure 20b, as shown and described below in connection with FIGS. 2A-2F.

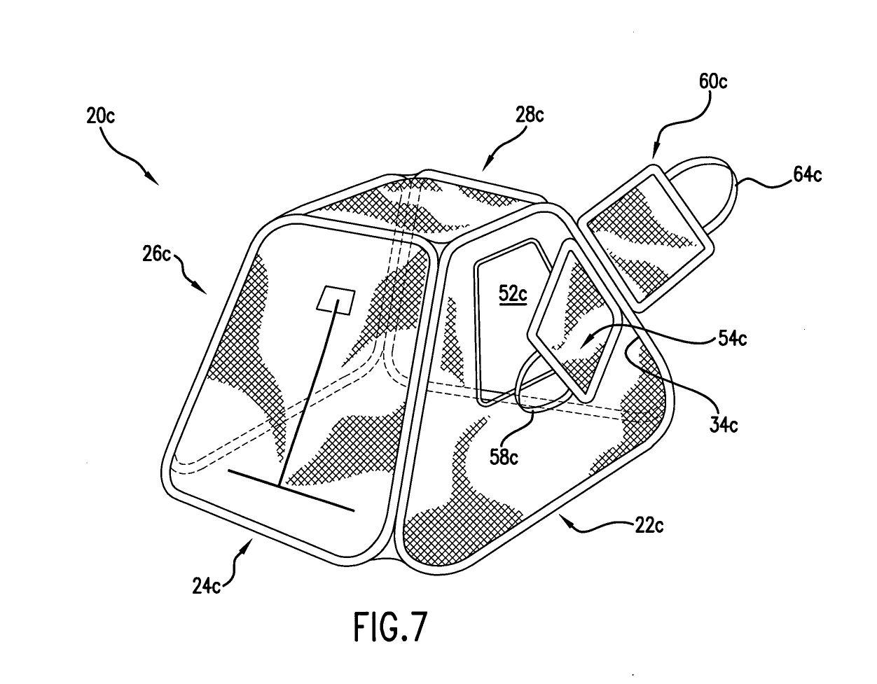

FIG. 7 illustrates another embodiment according to the present invention, where, the structure 20c is the same as the structure 20 shown in FIG. 1 except that the cover pieces 54c and 60c are hingedly connected to the right side 34c of the panel 22c and the left side 30c of the panel 28c, respectively. Otherwise the same elements in both FIGS. 1 and 7 are represented by the same numeral designations except that a “c” is added to the designations in FIG. 7. Each cover piece 54b, 60b can be hingedly connected (e.g., by stitching) to the side 30c or 34c, so that each cover piece 54c, 60c can be used as a sideway pivoting window cover (e.g., for an opening 52c acting as an opening), as well as functioning to bind and store the structure 20c, as shown and described below in connection with FIGS. 2A-2F.

FIG. 8 illustrates another embodiment according to the present invention, where the structure 20d is comprised of a single panel 22d that can have the same construction as the panel 22 above. Cover pieces 54d and 60d are hingedly connected to one side of the panel 22d, and function to enclose and cover the single panel 22d after the structure 20d has been twisted and folded to reduce the size of the structure 20d in accordance with the steps shown in FIGS. 2A-2F.

FIG. 9 illustrates another embodiment according to the present invention, where the structure 20e utilizes the same principles as the structure 20 shown in FIG. 1. The structure 20e in FIG. 9 can be the same as the underlying structure shown in FIG. 1 of U.S. Pat. No. 5,778,915, whose disclosure is incorporated by this reference as though set forth fully herein. Cover pieces 54e and 60e are hingedly connected to the fabric material 42e of a panel 22e.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A collapsible structure, comprising:
a plurality of panels, the plurality of panels including at least a first panel and a second panel, each panel having a foldable frame member that has a folded and an unfolded orientation, with a fabric material covering portions of each respective frame member to form the panel for each frame member when the frame member is in the unfolded orientation, each panel having a left side and a right side;
wherein the left side of each panel is hingedly coupled to the right side of an adjacent panel to form a ring of panels;
a first cover piece defining a planar body, the first cover piece attached to the first panel;
a second cover piece defining a planar body, the second cover piece attached to the second panel; and
wherein the panels are twisted and folded so that the frame members of the panels are in their folded orientation so as to reduce the size of the panels, with the panels sandwiched between the first and second cover pieces.

2. The structure of claim 1, wherein each panel has a sleeve that retains the respective frame member for the panel.

3. The structure of claim 1, wherein each panel has a sleeve that retains the respective frame member for the panel, and wherein the sleeve of the support member at the first portion is stitched to the sleeve of the second panel at the left side of the second panel, and the sleeve of the support member at the second portion is stitched to the sleeve of the third panel at the right side of the third panel.

4. The structure of claim 1, wherein the second cover piece has a handle.

5. The structure of claim 1, wherein the first cover piece has a shoulder strap.

6. The structure of claim 1, further including a connector that secures the first cover piece to the second cover piece when the panels are sandwiched between the cover pieces.

7. The structure of claim 1, wherein the first cover piece is hingedly coupled to a side of the first panel.

8. The structure of claim 1, wherein the first cover piece is hingedly coupled to the fabric material of the first panel.

9. A collapsible structure, comprising:
a plurality of panels, the plurality of panels including at least a first panel and a second panel, each panel having a foldable frame member that has a folded and an unfolded orientation, with a fabric material covering portions of each respective frame member to form the panel for each frame member when the frame member is in the unfolded orientation, each panel having a left side and a right side;
wherein the left side of each panel is hingedly coupled to the right side of an adjacent panel to form a ring of panels;
a first cover piece defining a planar body, the first cover piece attached to the first panel;
a second cover piece defining a planar body, the second cover piece attached to the first panel; and
wherein the panels are twisted and folded so that the frame members of the panels are in their folded orientation so as to reduce the size of the panels, with the panels sandwiched between the first and second cover pieces.

10. The structure of claim 9, wherein each panel has a sleeve that retains the respective frame member for the panel.

11. The structure of claim 9, wherein each panel has a sleeve that retains the respective frame member for the panel, and wherein the sleeve of the support member at the first portion is stitched to the sleeve of the second panel at the left side of the second panel, and the sleeve of the support member at the second portion is stitched to the sleeve of the third panel at the right side of the third panel.

12. The structure of claim 9, wherein the second cover piece has a handle.

13. The structure of claim 9, wherein the first cover piece has a shoulder strap.

14. The structure of claim 9, further including a connector that secures the first cover piece to the second cover piece when the panels are sandwiched between the cover pieces.

15. The structure of claim 9, wherein the first cover piece is hingedly coupled to a side of the first panel.

16. The structure of claim 9, wherein the first cover piece is hingedly coupled to the fabric material of the first panel.

17. A method of transporting a collapsible structure, comprising:
a. providing a collapsible structure, comprising:
a plurality of panels, the plurality of panels including at least a first panel and a second panel, each panel having a foldable frame member that has a folded and an unfolded orientation, with a fabric material covering portions of each respective frame member to form the panel for each frame member when the frame member is in the unfolded orientation, each panel having a left side and a right side;
wherein the left side of each panel is hingedly coupled to the right side of an adjacent panel to form a ring of panels;
a first cover piece defining a planar body, the first cover piece attached to the first panel and having a carrying mechanism;
a second cover piece defining a planar body, the second cover piece attached to the second panel;
b. twisting and folding the panels so that the frame members of the panels are in their folded orientation so as to reduce the size of the panels;
c. positioning the folded panels between the first and second cover pieces;
d. securing the first cover piece to the second cover piece; and
e. carrying the structure via the carrying mechanism.

18. The method of claim 17, wherein the carrying mechanism is a handle.

19. The method of claim 17, wherein the carrying mechanism is a shoulder strap.
